(19) United States
(12) Patent Application Publication
(10) Pub. No.: US 2023/0238720 A1
(43) Pub. Date: Jul. 27, 2023

(54) Coaxial Cable Connector

(71) Applicant: EZCONN CORPORATION, New Taipei City (TW)

(72) Inventors: Kai-Chih WEI, New Taipei City (TW); Kai-Wei HUANG, New Taipei City (TW)

(21) Appl. No.: 18/099,512

(22) Filed: Jan. 20, 2023

(30) Foreign Application Priority Data
Jan. 21, 2022 (TW) 111200863

(51) Int. Cl. H01R 9/05

(52) U.S. Cl. CPC H01R 9/0521; H01R 9/0524; H01R 9/0527

(57) ABSTRACT

A coaxial cable connector is provided in the present invention. The coaxial cable connector comprises a nut and a mandrel. The nut surrounds an axis, the nut comprising a body member and an extension member, the body member is connected to the extension member, and the body member has a threaded section. The mandrel surrounds the axis, arranged correspondingly to the nut, and includes a head and a body, the head is connected to the body. Wherein the mandrel is disposed passed through the nut, and when the mandrel is passed through the nut, the head is in contact with the body member of the nut through the threaded section, and the body is in close contact with the extension member.

### RELATED APPLICATIONS

This application claims priority to TW Application Ser. No. 111200863, filed on Jan. 21, 2022, which is incorporated herein by reference in its entirety.

### TECHNICAL FIELD

The present invention is related to a coaxial cable connector, especially, related to a coaxial cable connector with good electrical connectivity and does not need to use special compression tools for installation.

### BACKGROUND

To face the advent of a highly information-based society, communication infrastructure is needed to transmit various kinds of information, such as voice, text, data, images, etc. Accordingly, the optical communication network was developed to replace the conventional copper cable networks for huge information transmission. As known, in the field of optical communication, the optical fiber is especially suitable for serving as the medium for light transmission over long distances due to its advantages of low loss and wide bandwidth.

TV reception is mainly based on cable TV. The signal of the cable TV is transmitted to the receiving TV by a coaxial cable. This coaxial cable connects to the cable TV decoders, cassette recorders/digital video discs (VCR/DVD) hard disk digital recorders, satellite receivers, video games, TV signal distribution splitters, and switch connections via the screw-on F-Type connectors.

It is known that the grounding electrical connection of the conventional rotary F-type connector often has a problem of poor contact. The reason is that when the nut of the F-type connector is connected with the threaded interface connector of the above-mentioned equipment, the nut and the inner sleeve of the F-type connector is not in full contact, and the inner sleeve is not in contact with the threaded interface connector. The above-mentioned poor contact will cause the grounding of the connector body and the threaded interface connector to deteriorate, which will reduce the electrical signal transmission performance and cause bad contact between them. Other than that, when the user pulls the coaxial cable of the coaxial cable connector, it is easy to cause the coaxial cable to loosen, thereby causing unstable signal transmission. Therefore, how to improve the above problems to provide users with more satisfactory products have become an important problem to be solved.

In a prior art, in order to maintain the ground connection between the nut and the mandrel of the connector, via installing a ground connection element such as a shrapnel between the nut and the mandrel, and through the operation of rotation and compression to achieve a tight connection. However, in this way, the connector still has the problem of component loosening after being shaken or moved. Moreover, a compression tool is still required to compress the connector so as to achieve the purpose of tight bonding between components. Furthermore, when an additional grounding connection element is installed between the nut and the mandrel, it will undoubtedly increase the resistance of the overall connector, which violates the purpose of achieving good continuous grounding. In other words, the use of the prior art connectors not only requires extra labor costs and tool costs, but also fails to solve the problem of signal instability after the coaxial cable connector is shaken and the problem of improving grounding continuity. Therefore, how to Improvements to the above-mentioned problems to provide users with more satisfactory products have become an important issue that the present invention wants to solve urgently.

### SUMMARY

Therefore, one of the purposes of the present invention is to provide a coaxial cable connector, by minimizing the number of components to reduce the coaxial cable shaking, the components cannot maintain close contact, and then the problem of not being able to maintain good grounding.

Another purpose of the present invention is to provide a coaxial cable connector, which is designed to directly contact the nut and the mandrel, instead of adding a conductive element between the nut and the mandrel, so as to reduce the resistance between the components.

Another purpose of the present invention is to provide a coaxial cable connector, via designing the locking structure on the mandrel, the assembly can be completed by interlocking with the locking structure without using a compression tool.

To achieve the above-mentioned purpose, the present invention proposes a coaxial cable connector. The coaxial cable connector comprises a nut and a mandrel. The nut surrounds an axis, the nut comprising a body member and an extension member, the body member is connected to the extension member, and the body member has a threaded section. The mandrel surrounds the axis, arranged correspondingly to the nut, and includes a head and a body, the head is connected to the body. Wherein the mandrel is disposed passed through the nut, and when the mandrel is passed through the nut, the head is in contact with the body member of the nut through the threaded section, and the body is in close contact with the extension member.

In some embodiments, wherein the body member and the extension member are integrally formed.

In some embodiments, wherein the extension member is elastic.

In some embodiments, wherein the body member and the extension member are electrically connected.

In some embodiments, wherein the extension member has a base end and a tail end, the base end is connected to the tail end, and the distance between the base end and the axis is not greater than the distance between the tail end and the axis.

In some embodiments, wherein the extension member has a base end and a tail end, the base end is connected to the tail end, and the extension member connected to the body member through the base end.

In some embodiments, wherein the extension member has a base end, a tail end and a at least one groove, the base end is connected to the tail end, and the at least one groove is formed along the base end to the tail end.

In some embodiments, wherein the extension member has a base end and a tail end, the base end is connected to the tail end, and the tail end is a hook, the hook is arranged to extend outward in a direction away from the axis.

In some embodiments, wherein when the mandrel passes through the nut, the body member pushes against the extension member to make the extension member away from the axis.

In some embodiments, wherein the mandrel has a at least one stopper, and the at least one stopper is disposed on the outer surface of the body of the mandrel.

In some embodiments, wherein the at least one stopper protrudes outward in a direction away from the axis.

In some embodiments, wherein when the mandrel is passed through the nut, the extension member is pushed against the stopper so that the body of the mandrel moves in the direction of the axis.

In some embodiments, wherein when the mandrel is passed through the nut, the extension member is pushed against the stopper, and the extension member is clamped on the mandrel through the stopper.

In some embodiments, wherein the at least one stopper has at least one outer diameter, when the quantity of the at least one stopper is multiple, the outer diameters of the stoppers are different.

In some embodiments, wherein the at least one stopper has at least one outer diameter, when the quantity of the at least one stopper is multiple, the outer diameters of the stoppers are the same.

In some embodiments, further comprising a sleeve arranged around the axis and connected to the nut.

In some embodiments, further comprising a sleeve, wherein the sleeve has a first sleeve end and a second sleeve end, and the first sleeve end is in contact with the body member and the extension member.

In some embodiments, wherein the extension member has a base end and a tail end, the base end is connected to the tail end, and the tail end is a hook, the first sleeve end is disposed on the extension member through the hook.

In some embodiments, further comprising a sleeve, wherein in radial direction, the distance between the sleeve and the axis is greater than the distance between the extension member.

In some embodiments, further comprising a ring, the ring is disposed passed between the nut and the sleeve.

In summary, the present invention provides a coaxial cable connector. Via the design of the direct contact between the extension member of the nut and the body of the mandrel to achieve the function of grounding continuity, and reduce the resistance of the nut and the mandrel at the same time. In addition, when the mandrel is gradually installed on the nut, because the stopper design on the mandrel and the extension member of the nut push against each other, the body of the mandrel gradually shrinks inward toward the axis, achieving the purpose of engaging the nut and the mandrel.

### BRIEF DESCRIPTION OF THE DRAWINGS

Unless specified otherwise, the accompanying drawings illustrate aspects of the innovative subject matter described herein. Referring to the drawings, wherein like reference numerals indicate similar parts throughout the several views, several examples of coaxial cable connector incorporating aspects of the presently disclosed principles are illustrated by way of example, and not by way of limitation.

FIG. 1 is a three-dimensional view of an embodiment of the coaxial cable connector of the present invention;

FIG. 2 is a three-dimensional exploded view of an embodiment of the coaxial cable connector of the present invention;

FIG. 3A is a side view of an embodiment of the nut of the coaxial cable connector of the present invention;

FIG. 3B is a three-dimensional view of an embodiment of the nut of the coaxial cable connector of the present invention;

FIG. 4A is a three-dimensional view of one embodiment of the mandrel of the coaxial cable connector of the present invention;

FIG. 4B is a sectional view of one embodiment of the mandrel of the coaxial cable connector of the present invention;

FIG. 5A is a sectional view of an embodiment of the coaxial cable connector of the present invention; and

FIG. 5B is a cross-sectional view of an embodiment of the coaxial cable connector of the present invention.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

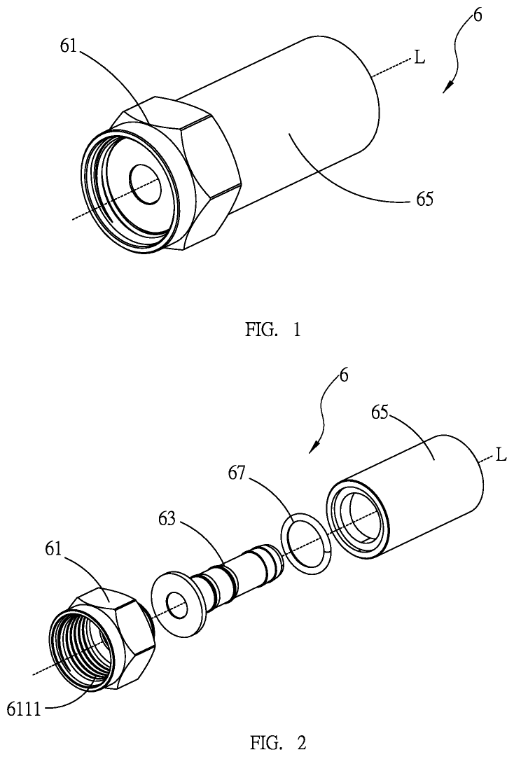

The present invention proposes a coaxial cable connector. Please refer to FIG. 1 and FIG. 2 at the same time. FIG. 1 is a perspective view of an embodiment of the coaxial cable connector of the present invention. FIG. 2 is an exploded perspective view of the embodiment of FIG. 1. In the coaxial cable connector 6 of this embodiment, it includes a nut 61, a mandrel 63 and a sleeve 65, the nut 61, the mandrel 63 and the sleeve 65 surround the axis L, and the nut 61, the mandrel The mandrel 63 and the sleeve 65 are arranged correspondingly. Furthermore, the sleeve 65 is connected to the nut 61, and the sleeve 65 is located on the outer layer of the mandrel 63 along the axis L. In addition, in this embodiment, a collar 67 is further included, and the collar 67 is passed between the nut 61 and the sleeve 65.

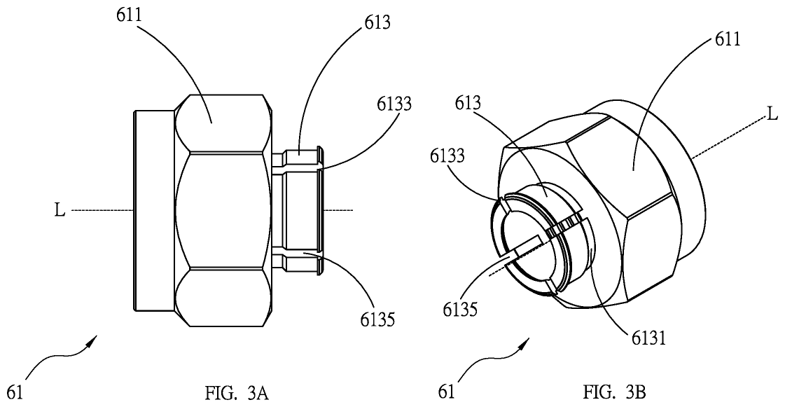

Next, the structure of the nut will be described in more detail. Please continue to refer to FIG. 1 and FIG. 2, and refer to FIG. 3A and FIG. 3B at the same time. FIG. 3A is a side view of one embodiment of the nut of the coaxial cable connector of the present invention. FIG. 3B is a perspective view of an embodiment of a nut of the coaxial cable connector of the present invention. The nut 61 includes a body member 611 and an extension member 613, the body member 611 is connected to the extension member 613, and the body member 611 has a threaded section 6111. In this embodiment, the body member 611 and the extension member 613 are integrally formed. In other words, the body member 611 and the extension member 613 are made of the same material. In this embodiment, the body member 611 and the extension member 613 is electrically conductive. In other words, the body member 611 and the extension member 613 of this embodiment are made of conductive materials, such as copper, tin, silver, nickel, gold, copper-gold alloy, copper-tin alloy, copper-nickel alloy or other polymers with good conductivity or non-metallic conductors, etc. In addition, the extension member 613 of this embodiment is elastic. Wherein, the extension member 613 has a base end 6131, a tail end 6133 and a groove 6135, the base end 6131 is connected to the tail end 6133, the extension member 613 is connected to the body member 611 through the base end 6131, and the groove 6135 is along the base end 6131. The tail end 6133 is a hook portion, and the tail end 6133 is arranged to extend outward in a direction away from the axis L.

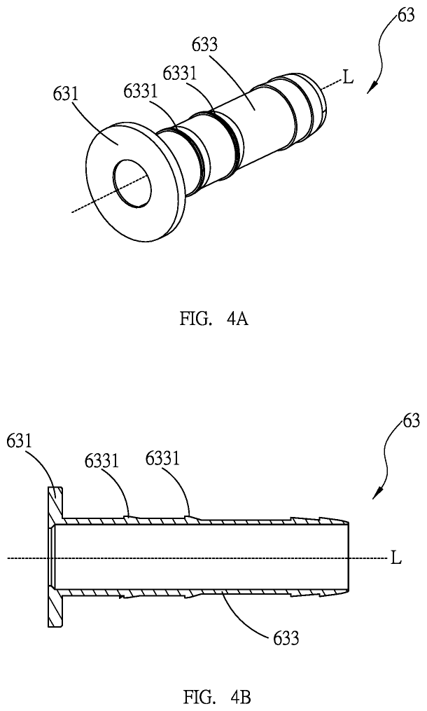

Next, the structure of the mandrel will be described in more detail. Please refer to FIG. 4A and FIG. 4B. FIG. 4A is a three-dimensional view of an embodiment of the mandrel of the coaxial cable connector of the present invention. FIG. 4B is an embodiment of the mandrel of the coaxial cable connector of the present invention Sectional view. The mandrel 63 includes a head 631 and a body 633, and the head 631 is connected to the body 633. The outer surface of the body 633 of the mandrel 63 has a stopper 6331, and the stopper 6331 protrudes toward the direction away from the axis L. The present invention does not limit the number of the stopper 6331, but when the number of the stopper is multiple, the outer diameters of the stopper 6331 can be the same or different. The outer diameter of the stopper 6331 here refers to the straight line distance of a single stopper 6331 protruding from the body 633. For example, when the number of stoppers is two and the outer diameters are different, the outer diameter of the stopper closer to the head of the mandrel can be larger than the stopper farther away from the head of the mandrel. However, the present invention does not limit the size and distribution of the outer diameter of the limiting member, the size of the outer diameter of the limiting member can increase or decrease sequentially from the head of the mandrel to the body, or the order is not limited.

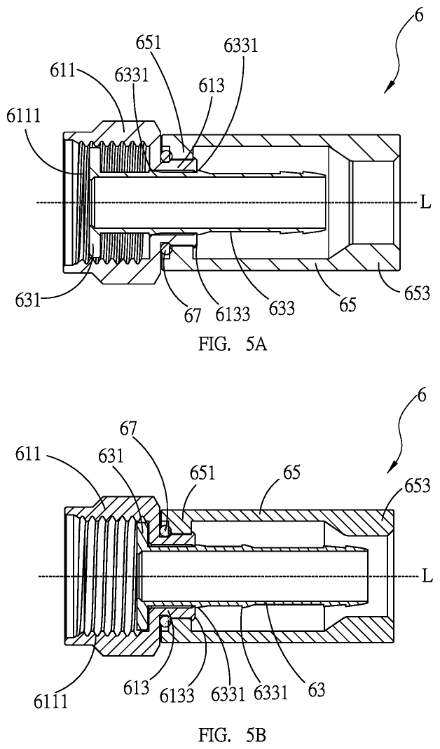

Finally, the assembly procedure and overall structure of the coaxial cable connector of this invention will be comprehensively described. Please refer to FIG. 5A and 5B, and when referring to nuts, refer to FIGS. 3A and 3B as appropriate, and similarly, when referring to mandrels, refer to FIGS. 4A and 4B as appropriate. FIG. 5A is the sectional view of an embodiment of the coaxial cable connector of the present invention. FIG. 5B is a sectional view of an embodiment of the coaxial cable connector of the present invention. To be more specific, FIG. 5A is a schematic diagram of the mandrel not yet completely passed through the nut, and FIG. 5A is a schematic diagram of the mandrel completely passed through the nut. For example, the nut 61 can be connected to the sleeve 65 first, and the sleeve 65 has a first sleeve end 651 and a second sleeve end 653, and the sleeve 65 contacts the screw through the first sleeve end 651. The body member 611 and the extension member 613 of the nut 61, in the radial direction, the distance between the sleeve 65 and the axis L is greater than the distance between the extension member 613 and the axis L, therefore, the sleeve 65 is arranged on the extension member 613. Through the design of the tail end 6133 of the extension member 613 as a hook portion and the assistance of the collar 67, the sleeve 65 can be well engaged with the extension member 613. When the mandrel 63 begins to pass through the nut 61 along the threaded section 6111 of the nut 61, the head 631 of the mandrel 63 is in contact with the body member 611 of the nut 61, while the body 633 of the mandrel 63 is in close contact with the extension member 613. It should be noted here that the tight contact between the body 633 of the mandrel 63 and the extension member 613 can be achieved through various methods. In this embodiment, the distance between the base end 6131 of the extension member 613 and the axis L is not greater than the distance between the tail end 6133 and the axis L. Therefore, when the body 633 of the mandrel 63 gradually passes through the extension member 613, since the extension member 613 is elastic and has a groove 6135 thereon, the body 633 of the mandrel 63 will push against the extension member 613, so that the extension member 613 is away from the axis L. A compressive engagement is formed between the extension member 613 and the body member 633, thereby achieving a tight fit. At the same time, due to the setting of the stopper 6331 of the mandrel 63, the extension member 613 will push against the stopper 6331 at the same time, the body 633 of the mandrel 63 is moved toward the axis L, so that the extension member 613 is clamped on the mandrel 63 through the stopper 6331.

In summary, when using the coaxial cable connector of the present invention to connect the joint of the electronic device, the system has the following advantages:

What needs to be explained first is that although the coaxial cable is not shown in the creation drawing, in actual operation, the coaxial cable is coaxially installed on the mandrel of the coaxial cable connector along the axis line. Generally speaking, a coaxial cable consists of a central conductor, an insulating layer, a braided layer, and a plastic sheath. And when the coaxial cable is installed in the coaxial cable connector, the central conductor will extend from the body of the mandrel through the head to the central channel in the nut and connector. The body of the mandrel accommodates the central conductor and insulating layer of the coaxial cable. The space surrounded by the cooperation between the body of the mandrel and the sleeve is used for the braiding layer and the plastic skin layer of the coaxial cable to be accommodated. Then, when the coaxial cable connector is initially installed in the direction of the connector of the electronic device, when the head of the mandrel is in contact with the joint, in other words, the head of the mandrel will contact the joint through the nut. At this time, although the coaxial cable connector is not completely installed in the electronic device. Because the mandrel and the electronic device are in pre-contact with each other through the nut, the conduction effect of electrical connection can be produced at the very beginning. And because of the direct and close contact between the mandrel and the nut, the resistance between the mandrel and the nut will be greatly reduced compared to the resistance of an additional conductive element installed between the nut and the mandrel. And through this design, the system can simultaneously achieve good grounding effect. Finally, when the mandrel is completely threaded through the nut, since the body of the mandrel cooperates with the extending part of the nut through the limiting part, it is not necessary to lock the nut and the mandrel with additional tools. And when the mandrel is gradually installed on the nut, the body of the mandrel is gradually shrunk toward the axis through the push between the extension of the nut and the body of the mandrel, thereby compressing the coaxial cable, thereby prevents the coaxial cable from coming out of the coaxial cable connector. In this way, the coaxial cable connector of the present invention can be installed without using a special compression tool.

Through the above description, the advantages of the coaxial cable connector of this invention can be summarized as follows:

First, the coaxial cable connector of the present invention can maintain continuous grounding through the design of the direct contact between the body of the mandrel and the extension of the nut no matter in any process of preliminary installation or complete installation to ensure the quality of signal transmission.

Second, the present invention does not need to use professional special compression tools. It only needs to rotate the nut and the mandrel to produce relative movement, so that the surrounding space for receiving the coaxial cable can be reduced, thereby effectively preventing the coaxial cable from being separated.

Third, the number of components in this invention is small, and the structure is exquisite and simple, which can effectively reduce the cost, and can effectively reduce the resistance formed between the components.

The presently disclosed inventive concepts are not intended to be limited to the embodiments shown herein, but are to be accorded their full scope consistent with the principles underlying the disclosed concepts herein. Directions and references to an element, such as “up,” “down,”, “upper,” “lower,” “horizontal,” “vertical,” “left,” “right,” and the like, do not imply absolute relationships, positions, and/or orientations. Terms of an element, such as “first” and “second” are not literal, but, distinguishing terms. As used herein, terms “comprises” or “comprising” encompass the notions of “including” and “having” and specify the presence of elements, operations, and/or groups or combinations thereof and do not imply preclusion of the presence or addition of one or more other elements, operations and/or groups or combinations thereof. Sequence of operations do not imply absoluteness unless specifically so stated. Reference to an element in the singular, such as by use of the article “a” or “an”, is not intended to mean “one and only one” unless specifically so stated, but rather “one or more”. As used herein, “and/or” means “and” or “or”, as well as “and” and “or.” As used herein, ranges and subranges mean all ranges including whole and/or fractional values therein and language which defines or modifies ranges and subranges, such as “at least,” “greater than,” “less than,” “no more than,” and the like, mean subranges and/or an upper or lower limit. All structural and functional equivalents to the elements of the various embodiments described throughout the disclosure that are known or later come to be known to those of ordinary skill in the relevant art are intended to be encompassed by the features described and claimed herein. Moreover, nothing disclosed herein is intended to be dedicated to the public regardless of whether such disclosure may ultimately explicitly be recited in the claims. No element or concept disclosed herein or hereafter presented shall be construed under the provisions of 35 USC 112(f) unless the element or concept is expressly recited using the phrase “means for” or “step for”.

In view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in the following claims and any claims presented anytime throughout prosecution of this application or any application claiming benefit of or priority from this application.

What is claimed is:

1. A coaxial cable connector, comprising:
a nut, surrounding an axis, the nut comprising a body member and an extension member, the body member is connected to the extension member, and the body member has a threaded section;
a mandrel, surrounding the axis, arranged correspondingly to the nut, and includes a head and a body, the head is connected to the body; and
wherein the mandrel is disposed passed through the nut, and when the mandrel is passed through the nut, the head is in contact with the body member of the nut through the threaded section, and the body is in close contact with the extension member.

2. The coaxial cable connector of claim 1, wherein the body member and the extension member are integrally formed.

3. The coaxial cable connector of claim 1, wherein the extension member is elastic.

4. The coaxial cable connector of claim 1, wherein the body member and the extension member are electrically connected.

5. The coaxial cable connector of claim 1, wherein the extension member has a base end and a tail end, the base end is connected to the tail end, and the distance between the base end and the axis is not greater than the distance between the tail end and the axis.

6. The coaxial cable connector of claim 1, wherein the extension member has a base end and a tail end, the base end is connected to the tail end, and the extension member connected to the body member through the base end.

7. The coaxial cable connector of claim 1, wherein the extension member has a base end, a tail end and a at least one groove, the base end is connected to the tail end, and the at least one groove is formed along the base end to the tail end.

8. The coaxial cable connector of claim 1, wherein the extension member has a base end and a tail end, the base end is connected to the tail end, and the tail end is a hook, the hook is arranged to extend outward in a direction away from the axis.

9. The coaxial cable connector of claim 1, wherein when the mandrel passes through the nut, the body member pushes against the extension member to make the extension member away from the axis.

10. The coaxial cable connector of claim 1, wherein the mandrel has a at least one stopper, and the at least one stopper is disposed on the outer surface of the body of the mandrel.

11. The coaxial cable connector of claim 10, wherein the at least one stopper protrudes outward in a direction away from the axis.

12. The coaxial cable connector of claim 10, wherein when the mandrel is passed through the nut, the extension member is pushed against the stopper so that the body of the mandrel moves in the direction of the axis.

13. The coaxial cable connector of claim 10, wherein when the mandrel is passed through the nut, the extension member is pushed against the stopper, and the extension member is clamped on the mandrel through the stopper.

14. The coaxial cable connector of claim 10, wherein the at least one stopper has at least one outer diameter, when the quantity of the at least one stopper is multiple, the outer diameters of the stoppers are different.

15. A coaxial cable connector of claim 10, wherein the at least one stopper has at least one outer diameter, when the quantity of the at least one stopper is multiple, the outer diameters of the stoppers are the same.

16. The coaxial cable connector of claim 10, further comprising a sleeve arranged around the axis and connected to the nut.

17. The coaxial cable connector of claim 1, further comprising a sleeve, wherein the sleeve has a first sleeve end and a second sleeve end, and the first sleeve end is in contact with the body member and the extension member.

18. The coaxial cable connector of claim 17, wherein the extension member has a base end and a tail end, the base end is connected to the tail end, and the tail end is a hook, the first sleeve end is disposed on the extension member through the hook.

19. The coaxial cable connector of claim 1, further comprising a sleeve, wherein in radial direction, the distance between the sleeve and the axis is greater than the distance between the extension member.

20. The coaxial cable connector of claim 16, further comprising a ring, the ring is disposed passed between the nut and the sleeve.
